(19) United States
(12) Patent Application Publication
(10) Pub. No.: US 2026/0270267 A1
(43) Pub. Date: Sep. 10, 2026

(54) Predicting Legitimacy of User Access to Available Enterprise Apps

(71) Applicant: Zscaler, Inc., San Jose, CA (US)

(72) Inventor: Chenhui Hu, Boston, MA (US)

(73) Assignee: Zscaler, Inc., San Jose, CA (US)

(21) Appl. No.: 19/070,801

(22) Filed: Mar. 5, 2025

(51) Int. Cl. H04L 9/40

(52) U.S. Cl. CPC H04L 63/102

(57) ABSTRACT

Systems and methods are provided for predicting the validity or authorization of a user to access applications (apps) in a network. A method, according to one implementation, includes a step of obtaining transaction logs that include a) user features related to a plurality of users of an organization, b) app features related to a plurality of apps used within the organization, and c) user-app interaction information related to requests by users to access apps in addition to responses to the requests to either permit or deny user access. Also, the method includes a step of applying a collaborative filtering technique on the transaction logs to train an Artificial Intelligence (AI) model for predicting whether a new user is legitimately permitted access to one or more of the plurality of apps.

### TECHNICAL FIELD

The present disclosure generally relates to networking systems and methods. More particularly, the present disclosure relates to Artificial Intelligence (AI) models for predicting whether a new user can legitimately access an app, whereby the AI models may use Collaborative Filtering (CF) for more accurate prediction results.

### BACKGROUND

Generally, an organization may have a suite of software applications (apps) that might be available to various employees or groups of employees. In some cases, an organization may establish a well-defined access policy that offers a plan regarding which users should legitimately be given permission to access or use certain apps. For example, such a policy may be based on one or two factors, such as a user's job title or a department in which he or she works. The user may be required to manually request access (e.g., by opening an IT ticket) in order to gain access to other apps he or she may need in order to perform their duties. Next, the IT team may need to review the request and manually download the apps onto the user's computer or provide some other type of access privileges. Thus, the analysis of the legitimacy of a user to access apps and a resulting permission or denial response are normally manual processes, which require time and attention by IT staff. Also, any delays in the process can be a frustration to users trying to access the apps they may need to perform their jobs. It would be beneficial for organizations to offer a positive user experience in this regard to allow users to perform their tasks without unnecessary interruptions. There is therefore a need for improvements with respect to more efficient user-app access policies for organizations.

### BRIEF SUMMARY

The present disclosure focuses on systems and methods for predicting user-app access. According to one implementation, a method includes a step of obtaining transaction logs that include a) user features related to a plurality of users of an organization, b) app features related to a plurality of apps used within the organization, and c) user-app interaction information related to requests by users to access apps in addition to responses to the requests to either permit or deny user access. The method further includes a step of applying a collaborative filtering technique on the transaction logs to train an Artificial Intelligence (AI) model for predicting whether a new user is legitimately permitted access to one or more of the plurality of apps.

Furthermore, according to some embodiments, the user features may include a) skills and/or expertise of a user, b) experience and/or background of the user, c) department and/or team to which the user is assigned, d) job title of the user, e) city, office, and/or location where the user works, f) projects on which the user contributes, g) a number of days, within a predetermined time period, that a user attempts to access any of the apps, h) number of transactions that the user performs within the predetermined time period, and/or any other suitable features. Also, the app features may include a) a name of an app, b) an app type of the app, c) a domain name associated with the organization within which the app is used, d) IP address of network equipment associated with the app, e) one or more ports to which the app is assigned, and/or any other suitable features.

The method, in some embodiments, may further include steps of 1) converting the user features for each user into a multi-dimensional user vector, 2) converting the app features for each app into a multi-dimensional app vector, and 3) utilizing a connectivity graph to analyze similarities among user vectors, similarities among app vectors, and the user-app interaction information regarding access requests and responses to the requests to either permit or deny user access. According to some implementations, the action of analyzing similarities among user vectors and analyzing similarities among app vectors may include a) assigning weights to different user features and app features, and b) calculating a prediction score based on the similarities in the connectivity graph. Also, the method may include steps of a) utilizing a Strongest Connected Components (SCC) detection algorithm to determine similarities, and b) applying the results of the SCC detection algorithm to perform an app segmentation procedure to create an access policy for the organization.

In addition, the transaction logs in the method may be historical transaction logs, wherein the method may further include a step of retraining the AI model based on newly obtained user access information. The collaborative filtering technique, for example, may be configured to enable the AI model to increase a number of true positives and true negatives and reduce a number of false positives and false negatives. For instance, true positives may be defined as correctly predicting user access permission to valid users, true negatives may be defined as correcting predicting user access denial to invalid users, false positives may be defined as incorrectly predicting user access permission to invalid users, and false negatives may be defined as incorrectly predicting user access denial to valid users.

The AI model may be configured to automatically predict whether an access request would result in a user access permission or a user access denial without the need for the user to open a ticket. The method, according to some embodiments, may be incorporated in a system arranged for implementation within a cloud-based zero trust platform and/or network access platform. Also, in some embodiments, the method may further include a step of periodically updating an access policy defined by the AI model based on newly obtained transaction logs.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 is a block diagram illustrating a computer system of a network administrator, according to various embodiments.

FIG. 2 is a diagram illustrating a system workflow for generating an Artificial Intelligence (AI) model to determine a policy for defining the legitimacy of users of an organization to access certain applications (apps), according to various embodiments.

FIG. 3 is a diagram illustrating the access prediction module shown in FIG. 2, according to various embodiments.

FIG. 4 is a chart illustrating an example of the legitimacy of users to access certain apps based on a collaborative filtering methodology, according to various embodiments.

FIG. 5 is a flow diagram illustrating a method for predicting user access to apps in an organization, according to various embodiments.

### DETAILED DESCRIPTION

The present disclosure relates to systems and methods for predicting one or more applications (apps) of a group of apps that a new user in an organization (e.g., business, enterprise, university, etc.) should legitimately have access to when he or she is onboarded in the organization. Normally, a policy may be used that limits user access based on two or three factors, such as job title, department, or team of the new user. However, since these policies might not always be well defined, the embodiments of the present disclosure are configured to use Artificial Intelligence (AI) models or Machine Learning (ML) models to predict whether future users should be given access to one or more of the apps. In particular, by using a Collaborative Filtering (CF) technique or algorithm, the systems and methods described herein are able to more accurately predict whether access to apps should be permitted or denied for each specific user.

Predicting user access using CF results in an increase in the correct identification of users who are legitimately allowed access to certain apps and the correct identification of invalid users who are rightly denied access. Also, the results of the systems and methods of the present disclosure also result in a decrease in the incorrect identification of users who should legitimately be given access but are denied as well as the incorrect identification of users who should be denied access but are permitted access. The user-app access prediction systems and methods may be incorporated in cloud-based servers (e.g., zero trust systems) for improving access policies and enabling an automated permission/denial analysis without the need for users to open IT tickets. The user-app access procedures may be applicable to any suitable type of user access system to predict the legitimacy of user access with respect to apps, accounts, benefits, privileges, etc. within an organizational environment.

There has thus been outlined, rather broadly, the features of the present disclosure in order that the detailed description may be better understood, and in order that the present contribution to the art may be better appreciated. There are additional features of the various embodiments that will be described herein. It is to be understood that the present disclosure is not limited to the details of construction and to the arrangements of the components set forth in the following description or illustrated in the drawings. Rather, the embodiments of the present disclosure may be capable of other implementations and configurations and may be practiced or carried out in various ways. Also, it is to be understood that the phraseology and terminology employed are for the purpose of description and should not be regarded as limiting.

As such, those skilled in the art will appreciate that the inventive conception, upon which this disclosure is based, may readily be utilized as a basis for the designing of other structures, methods, and systems for carrying out the several purposes described in the present disclosure. Those skilled in the art will understand that the embodiments may include various equivalent constructions insofar as they do not depart from the spirit and scope of the present invention. Additional aspects and advantages of the present disclosure will be apparent from the following detailed description of exemplary embodiments which are illustrated in the accompanying drawings.

### Computing System

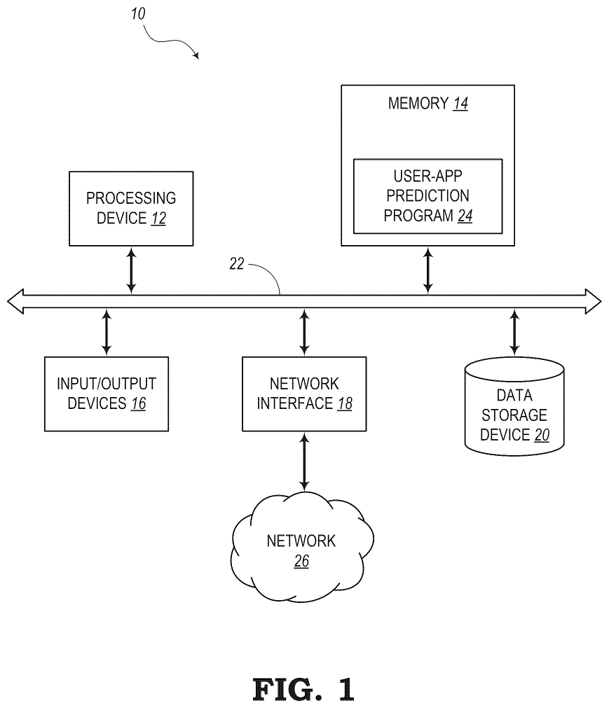

FIG. 1 is a block diagram illustrating an embodiment of a computing system 10 configured for use by a network administrator or manager of an organization or enterprise. As shown in its simplified form, the computing system 10 includes a processing device 12, memory 14, Input/Output (I/O) devices 16, a network interface 18, and a data storage device 20 (or database), interconnected with each other via a local interface 22 (or bus). The computing system 10 may be configured as a cloud-based system for providing services with respect to predicting user-app access within the organization or enterprise. In some embodiments, the computing system 10 may be incorporated in a zero trust architecture and may be configured to assist with services related to private access functionality and/or network access functionality.

Furthermore, the computing system 10 includes a user-app prediction program 24, which may be implemented in any suitable combination of hardware (e.g., in the processing device 12) and software/firmware (e.g., in the memory 14). The user-app prediction program 24 may be configured in suitable non-transitory computer-readable media and may have instructions that enable or cause the processing device 12 to perform certain actions as described in detail in the present disclosure.

The processing device 12 may include one or more processors or microprocessors, such as a Central Processing Unit (CPU), which is configured to execute instructions and process data. The processing device 12 may be a general-purpose processor, a special-purpose processor, an Application-Specific Integrated Circuit (ASIC), or any combination thereof. The processing device 12 is configured to perform various computational tasks and manage the operations of the computing system 10, including executing software instructions stored in the memory 14. In some embodiments, the processing device 12 may also include or be coupled to a Graphics Processing Unit (GPU), a Digital Signal Processor (DSP), or other specialized processing units that assist in performing specific functions such as image processing, machine learning, or data analysis. The processing device 12 may operate in conjunction with other components of the computing system 10, communicating via the local interface 22.

The memory 14 in the computing system 10 may include any combination of volatile and non-volatile memory components, such as Random-Access Memory (RAM), Read-Only Memory (ROM), flash memory, and other forms of computer-readable storage media. The memory 14 is configured to store software programs, applications, and data that are executed or processed by the processing device 12. The memory 14 may also store an Operating System (O/S) and/or operating instructions that manage the overall operation of the computing system 10. In some embodiments, the memory 14 may be further subdivided into different types, such as main memory (e.g., dynamic RAM) for temporary storage of active data, and secondary memory (e.g., non-volatile memory) for storing data persistently even when the system is powered down. The memory 14 may be dynamically allocated by the computing system 10, and it may be accessible by the processing device 12 and other components via the local interface 22.

The I/O devices 16 allow the computing system 10 to interact with a user, the external environment, and other systems. Input devices may include, but are not limited to, keyboards, mice, touchscreens, microphones, and other sensors or control devices that enable the user to input commands or data into the system. Output devices may include displays, printers, speakers, or haptic feedback devices that allow the computing system 10 to convey information or feedback to the user or external systems. In some embodiments, the I/O devices 16 may also include peripheral devices such as cameras, scanners, or biometric sensors. These I/O devices 16 may be directly connected to the computing system 10 or may communicate with the computing system 10 wirelessly, such as via the network interface 18.

The network interface 18 facilitates communication between the computing system 10 and external networks, such as network 26, a local area network (LAN), a wide area network (WAN), or the Internet. The network interface 18 may include both wired and wireless communication capabilities, such as Ethernet, Wi-Fi, Bluetooth, or other protocols. The network interface 18 enables the computing system 10 to transmit and receive data, connect to remote servers, or access cloud-based services. In some embodiments, the network interface 18 may be integrated with other components of the computing system 10 or implemented as a separate hardware module, and it may support various network protocols, including Transmission Control Protocol/Internet Protocol (TCP/IP), User Datagram Protocol (UDP), and others. The network interface 18 may also provide security features such as encryption, firewalls, and authentication mechanisms to ensure secure communication.

The data storage device 20 is configured to store data persistently, which may include structured data, unstructured data, program files, system logs, and other forms of digital information. The data storage device 20 may take various forms, such as a Hard Disk Drive (HDD), Solid-State Drive (SSD), or other non-volatile memory technologies. In some embodiments, the data storage device 20 is organized as a database, storing records, tables, and indexes that facilitate the efficient retrieval, updating, and management of data. The data storage device 20 may include multiple components and may be local to the computing system 10 and/or connected via a network to external storage resources, such as cloud-based storage platforms. The processing device 12 may interact with the data storage device 20 to retrieve and store data required for executing software applications, maintaining system logs, or providing data for analytical processes.

The various hardware components of the computing system 10, including the processing device 12, memory 14, I/O devices 16, network interface 18, and data storage device 20, communicate with each other over the local interface 22. This local interface 22 may be implemented as a bus, such as a system bus, memory bus, or input/output bus, which provides a communication pathway between the different components. The bus may be based on any standard bus architecture, including but not limited to Peripheral Component Interconnect (PCI), Universal Serial Bus (USB), or Advanced Microcontroller Bus Architecture (AMBA). In some embodiments, the local interface 22 may include multiple buses or communication channels that handle different types of data traffic, such as high-speed data transfers between the memory 14 and the processing device 12, or lower-speed communication with the I/O devices 16 or peripheral devices. The local interface 22 allows for the efficient exchange of data between components and ensures synchronized operation of the system.

The user-app prediction program 24 may be configured to analyze user features (of multiple users) and app features (of multiple apps) from historical transaction logs obtained in the organization. Using these user features and app features, the user-app prediction program 24 may further determine user-app interaction or connectivity information, which may define, for example, which characteristics of various users may be associated with access to various apps having other characteristics. Then, instead of requiring manual opening of tickets to provide access, which is common in conventional systems, the user-app prediction program 24 is configured to automatically predict whether a new user, based on features of this new user, should legitimately be permitted to gain access to one or more apps.

### Access Prediction System and Workflow

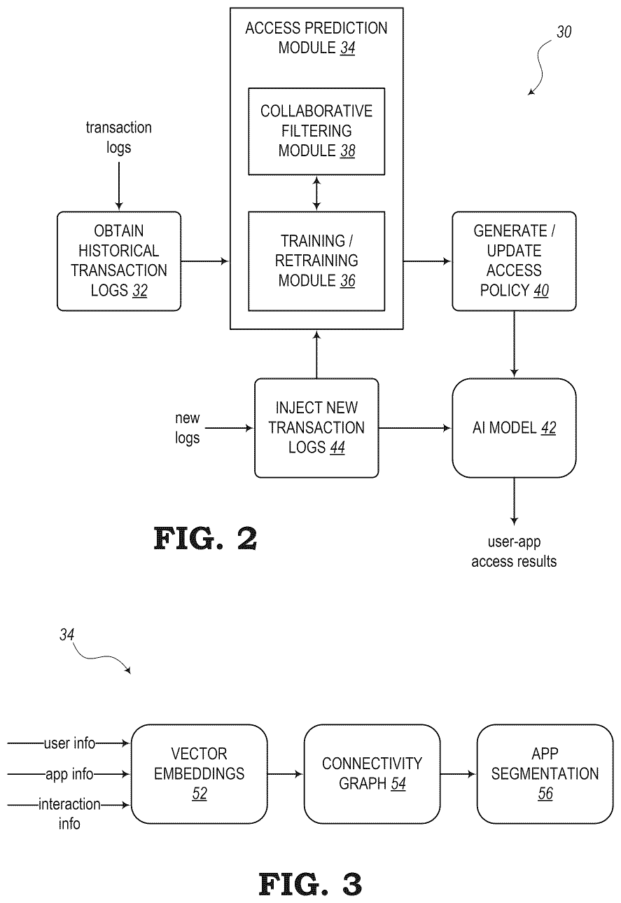

FIG. 2 is a diagram illustrating an embodiment of a user-app access system 30 that includes a certain system workflow for generating an AI model for determining a policy for defining the legitimacy of users of an organization to access certain apps. In particular, the user-app access system 30 is configured to provide a novel approach for predicting the user-app access in an organizational network, such as a network where private access and/or network access methodologies are utilized for analyzing, monitoring, and controlling network traffic. The user-app access system 30 is configured to obtain transaction logs that incorporate multiple dimensions of user features as well as multiple dimensions of app features. By using Collaborative Filtering (CF), the user-app access system 30 is able to effectively increase prediction of legitimate users who are permitted access while also reducing violations (e.g., unnecessary user blockings), which can of course lead to a better user experience.

As described in the present disclosure, the user-app system 30 is generally configured to learn access patterns of users and apps from transaction logs using CF. This may be similar to recommendation engines used for recommending media to users based on previous likes and dislikes. However, instead of likes and dislikes, the CF techniques used herein may define a positive aspect as a “permission” to access an app, while a negative aspect may be defined as a “denial” of access. From historical data, the user-app system 30 can learn user-app usage patterns and the intricacies of the interactions between users and apps to predict future user-app access. The user-app system 30 can use the predicted access patterns to improve access policy recommendations for the organization, where the policies and associated recommendations may be AI-based models for predicting access of new users.

As shown in FIG. 2, the user-app system 30 is configured to perform a step of obtaining historical transaction logs 32. The transaction logs 32 may include user information (features), app information (features), and interaction information defined as correlations or similarities among users and apps. The transaction logs 32 are passed to an access prediction module 34, which includes a training/retraining module 36 and a Collaborative Filtering (CF) module 36. The access prediction module 34 is configured to provide information such that the user-app system 30 can generate an access policy 40, which may be in the form of an AI model 42. In addition, the user-app system 30 includes a step of injecting new transaction logs 44 to the access prediction module 34 to enable retraining of the access policy 40 and AI model 42. In addition to retraining the AI model 42 with new logs, the new logs can also be applied directly to the AI model 42 to automatically obtain user-app access results defining which apps a new user may be permitted to access.

The user-app system 30 and associated workflow may include a first step of training a CF model using historical transaction logs. The CF process may be configured to take a user-app interaction matrix, user features, and app features as inputs. Each entry of the interaction matrix may have a positive value (e.g., binary 1, “yes,” thumbs up, access granted, access permitted, etc.) if the user should be allowed access to that app. Also, each entry may have a negative value (e.g., binary 0, “no,” thumbs down, access denied, etc.) if the user should not be allowed access to the app. The trained CF model can be used to predict access for new users.

Regarding user features, the transaction logs (and new logs) may include any number (or dimension) of features. An example of some of the user features that may be received by the access prediction module 34 includes a) skills and/or expertise of a user, b) experience and/or background of the user, c) department and/or team to which the user is assigned, d) job title of the user, e) city, office, and/or location where the user works, f) projects on which the user contributes, g) a number of days, within a predetermined time period, that a user attempts to access any of the apps, and/or h) number of transactions that the user performs within the predetermined time period. Regarding app features, the transaction logs may also include any number (or dimension) of features. An example of some of the app features that may be received by the access prediction module 34 includes a) a name of an app, b) an app type of the app, c) a domain name associated with the organization within which the app is used, d) IP address of network equipment associated with the app, and/or e) one or more ports to which the app is assigned.

The access prediction module 34 may be configured as an ML training module for training an ML model (or AI model 42), which may include supervised training using labeled data (i.e., historical transaction logs 32). The AI model 42, once trained (or retrained) and then deployed into production, may then be used, implemented, etc. according to various inference practices to actually predict whether a new user (or future users) will be granted access to one or more apps.

### Access Prediction Module

FIG. 3 is a diagram illustrating an embodiment of the access prediction module 34 shown in FIG. 2. As shown in this embodiment, the access prediction module 34 includes vector embeddings 52, the creation of a connectivity graph 54, and app segmentation 56. The access prediction module 34 may be configured to use predicted access to improve app segmentation and policy recommendations. The vector embeddings 52 are configured to receive logs (e.g., historical transaction logs 32 and new transaction logs 44). Again, the logs may include a) user information (e.g., user features with respect to multiple users), b) app information (e.g., app features with respect to multiple apps), and c) interaction information related to correlations, similarities, interconnections, etc. among the users and apps.

In operation, the access prediction module 34 may include a CF prediction, which uses prediction scores from the trained CF model to predict the future user-app access. Also, the access predication module 34 can add new transactions into the existing transaction log for retraining purposes. Regarding the vector embeddings 52, the user features for each user can be embedded as a multi-dimensional vector in multi-dimensional space. Also, the app features for each app can be embedded as a multi-dimensional vector in multi-dimensional space.

From the vector embeddings 52, the access prediction module 34 is configured to utilize the connectivity graph 54, whereby the user vectors and apps vectors can be plotted in one or more multi-dimensional graphs. Using the connectivity graph 54, the access prediction module 34 may be configured to analyze similarities among users, similarities among apps, and apply new user features with similarly permitted users and their respective apps. The similarities may be based on the observed transactions and the predicted transactions and may result in a prediction score or similarity score. Also, in some embodiments, the access prediction module 34 may be configured to assign weights to different features that exhibit greater similarity patterns and/or even eliminate certain features that are found to have little or no impact in determining similarity.

Then, the access prediction module 34 may be configured to pass information from the connectivity graph 54 (e.g., similarity scores, prediction scores, etc.) to the app segmentation 56 to perform app segmentation procedures. For example, the app segmentation may use a Strongest Connected Components (SCC) detection algorithm to segment the apps. The segmented app may be used to generate an updated version of the user access policy (e.g., policy recommendation), which can be used for generating or reconfiguring (updating) the AI model 42. Essentially, predicted transactions can be obtained from CF to perform app segmentation and policy recommendation.

In some embodiments, the app segmentation 56 may be configured as AI-powered app segmentation in which remote access solutions are able to grant full network access to VPNs, which may expose IPs and applications to the Internet. VPNs extend the internal network to remote devices and, by design, require inbound traffic, exposing a public attack surface. Thus, without proper network segmentation, a breach in one segment could compromise the organization's network. Therefore, the access prediction module 34 is configured to implement app segmentation 56 to simplify firewall rules. The private access and/or network access features of the present disclosure are configured to limit users only to the applications they are allowed to access. Application segmentation 56 lets security and IT teams organize applications into discrete groups and helps contain security threat at a more granular level, preventing attackers from accessing other parts of the network.

### Collaborative Filtering (CF)

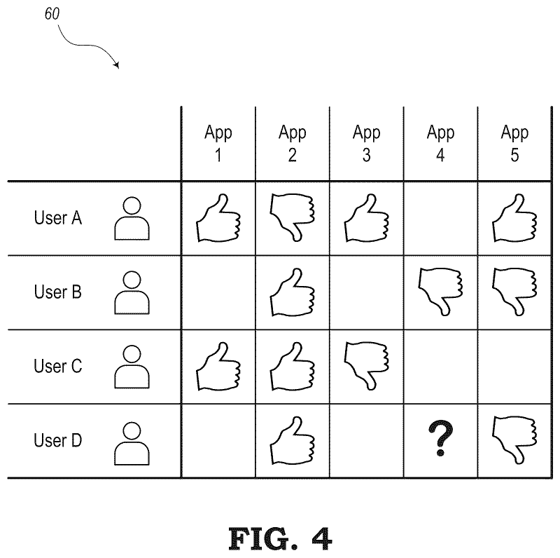

FIG. 4 is a chart 60 illustrating an example of a CF methodology. As shown in this example, the chart 60 shows a number of users (i.e., User A, User B, User C, and User D) and a number of apps (i.e., App 1, App 2, App 3, App 4, and App 5). It should be noted that a particular organization or enterprise may include any number of users and apps. Also, the Apps 1-5 may represent any applications (e.g., Jira, Confluence, Bitbucket, Salesforce, Slack, etc.) of any type and created by any developer. The chart 60 shows the legitimacy of users to access certain apps. A “thumbs up” symbol indicates that a specific user is permitted (or granted) access to a specific app and a “thumbs down” symbol indicates that a specific user is not allowed (or denied) access to a specific app. In this example, User A is permitted access to Apps 1, 3, and 5 and is denied access to App 2.

Using similarity scores or prediction scores as described with respect to FIG. 3, it may be noted that these scores may be visually perceptible from similarities of users and apps in the chart 60. Thus, if a prediction of user access is being determined for a certain new user, that user can be compared with the permission/denial patterns of other users. For example, to determine if User D might be permitted access to App 4, it may be noted that User B has similar permission of access with respect to App 2 and similar denial of access with respect to App 5. Therefore, since User B has already been denied access to App 4, in this example, User D may also be denied access based on CF methods.

### User-App Access Prediction Method

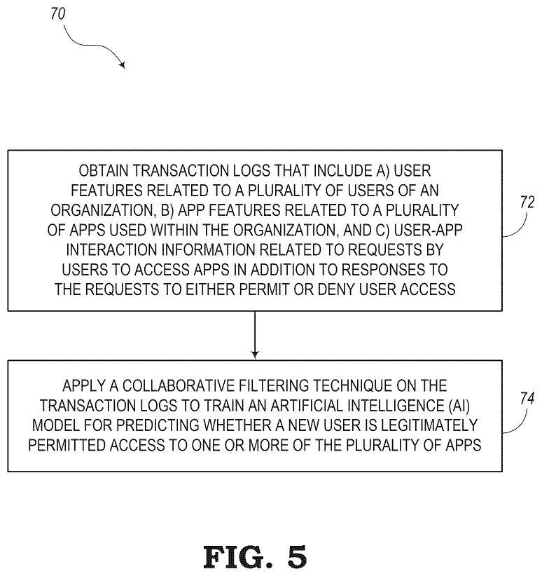

FIG. 5 is a flow diagram illustrating an embodiment of a method 70 for predicting user-app access. As illustrated, the method 70 includes a step (block 72) of obtaining transaction logs that include a) user features related to a plurality of users of an organization, b) app features related to a plurality of apps used within the organization, and c) user-app interaction information related to requests by users to access apps in addition to responses to the requests to either permit or deny user access. The method 70 further includes a step (block 74) of applying a collaborative filtering technique on the transaction logs to train an Artificial Intelligence (AI) model for predicting whether a new user is legitimately permitted access to one or more of the plurality of apps.

Furthermore, according to some embodiments, the user features may include a) skills and/or expertise of a user, b) experience and/or background of the user, c) department and/or team to which the user is assigned, d) job title of the user, e) city, office, and/or location where the user works, f) projects on which the user contributes, g) a number of days, within a predetermined time period, that a user attempts to access any of the apps, h) number of transactions that the user performs within the predetermined time period, and/or any other suitable features. Also, the app features may include a) a name of an app, b) an app type of the app, c) a domain name associated with the organization within which the app is used, d) IP address of network equipment associated with the app, e) one or more ports to which the app is assigned, and/or any other suitable features.

The method 70, in some embodiments, may further include steps of 1) converting the user features for each user into a multi-dimensional user vector, 2) converting the app features for each app into a multi-dimensional app vector, and 3) utilizing a connectivity graph to analyze similarities among user vectors, similarities among app vectors, and the user-app interaction information regarding access requests and responses to the requests to either permit or deny user access. According to some implementations, the action of analyzing similarities among user vectors and analyzing similarities among app vectors may include a) assigning weights to different user features and app features, and b) calculating a prediction score based on the similarities in the connectivity graph. Also, the method 70 may include steps of a) utilizing a Strongest Connected Components (SCC) detection algorithm to determine similarities, and b) applying the results of the SCC detection algorithm to perform an app segmentation procedure to create an access policy for the organization.

In addition, the transaction logs in the method 70 may be historical transaction logs, wherein the method 70 may further include a step of retraining the AI model based on newly obtained user access information. The collaborative filtering technique, for example, may be configured to enable the AI model to increase a number of true positives and true negatives and reduce a number of false positives and false negatives. For instance, true positives may be defined as correctly predicting user access permission to valid users, true negatives may be defined as correcting predicting user access denial to invalid users, false positives may be defined as incorrectly predicting user access permission to invalid users, and false negatives may be defined as incorrectly predicting user access denial to valid users.

The AI model described in block 74 may be configured to automatically predict whether an access request would result in a user access permission or a user access denial without the need for the user to open a ticket. The method 70, according to some embodiments, may be incorporated in a system arranged for implementation within a cloud-based zero trust platform and/or network access platform. Also, in some embodiments, the method 70 may further include a step of periodically updating an access policy defined by the AI model based on newly obtained transaction logs.

### Additional Considerations

The systems and methods of the present disclosure may be considered to be an improvement to prior access granting systems, particularly with respect to the use of CF to predict future user access. When tested, it has been found that the present disclosure indeed offers a better approach than conventional systems and improves precision and recall factors, such as by increasing true positives and true negatives and decreasing false positives and false negatives (e.g., violations), which can lead to a better user experience.

The CF algorithm can forecast future transactions. The system can inject the forecasted user access information into the transaction log, and then the system can generate an access policy, which can be improved in an ongoing manner with new transactions. In a sense, new transaction logs can be fed back to the start for injection with the historical data for training and/or retraining.

By monitoring a variety of different user features and app features, it is possible to determine an access policy based on anything that may be revealed in the ML models, which may not be anticipated or known by human analysis. In this way, the access determination is not left in the hands of a human operator, who may miss something. Also, one user may need access to one group of apps at one time, but then may need access to other applications in the following weeks or months. As such, since no employee is going to fit into a limited mold, the systems and methods described herein include a level of flexibility that is not seen in a conventional system that simply grants access of certain apps only to certain users only in certain departments or teams. For example, some employees may be put on a specific team, but they may also be tasked to do work outside of their regular workload and may be more in line with the workload of another team. In another example, one user may have certain skills in other areas that might be utilized more effectively if they were given permission to access other apps pertaining to work that overlaps with those special skills.

Again, the systems and methods described in the present disclosure may be configured to improve onboarding time for new employees. Since it can be faster than conventional systems, it can provide a greater customer experience. Also, the new user will not need to open or raise a ticket every time they want to gain access to a new app.

Also, in some embodiments, a back end of the CF algorithms may be based on some optimization algorithm. In addition, the systems may convert all the user features and app features into feature vectors, concatenate them, and then feed them into the optimization algorithm.

After the user features and app features are fed into the algorithm, the system is configured to get an outcome, which gives a prediction score to assign weights between the applications based on some measures of similarity. The prediction score measures the similarity of apps. The outcome may also include an embedding feature vector of an app and an embedding feature of a user.

After using CF, the system is able to get a better understanding of every application and every user. This understanding is captured as an output, like an embedding vector. For every app, the system is configured to have a new embedding vector. Then, with that embedding vector, the system can calculate some similarity score to determine, for example, that one app is very similar to some other app. If the similarity score is higher than a certain threshold (e.g., over 0.9 or 90%), then the system can determine that those two app are very similar. Then, if one user accesses one app, then he or she will likely want to access another app if the two apps have high similarly.

The systems and methods described herein are configured for utility for internal apps of an organization. Violations defined here may include unnecessarily blocking a user who should legitimately be granted access to an app. If the user is blocked based on a recommended policy, the system marks this as a violation and is able to re-analyze the AI model to upgrade the policy. Also, the system is configured to measure attack surface reduction, meaning how many incorrectly permitted accesses were given to unauthorized users. The system is configured to reduce the number of attack surface violations. When tested, it was determined that the systems and methods of the present disclosure, while using the CF algorithms, were able to achieve a reduction in both types of violations, which might normally be a trade-off for conventional system.

The systems and methods described herein are configured to predict user access using CF for reducing various violations (e.g., unnecessarily blocking valid users). The systems may be related to access control systems within an enterprise network. More particularly, the systems pertain to the use of collaborative filtering techniques to predict user access needs, thereby reducing improper blocking of applications for new employees and improving overall user experience.

Using conventional systems, new employees in many enterprises may simply be granted only basic access when they join. Then, they must then manually request access to additional applications, such as Jira, Confluence, Bitbucket, etc., through an IT or HR department. This manual process is time-consuming, inefficient, and negatively impacts productivity and user experience.

Conventional access control systems rely on historical transaction logs to define access policies. However, these systems fail to anticipate future access needs, often leading to improper user blockages and delays in granting access. Therefore, the present disclosure fulfills a need for a more intelligent, automated approach to predicting user access requirements and refining access policies accordingly.

The present disclosure introduces a novel method for predicting user access requirements using collaborative filtering. By analyzing historical access patterns, user attributes (such as department, job title, and activity history), and application features, the system forecasts which applications a user is likely to need in the near future. These predicted transactions are injected into the transaction logs, enabling the generation of more inclusive access policies that preemptively grant necessary permissions.

Thus, the systems and methods herein provide an intelligent, automated solution for predicting user access needs in enterprise environments. By leveraging collaborative filtering and new transaction injection, the systems minimize unnecessary user blockages, enhances security policies, and improves onboarding efficiency. The approach is particularly effective in zero trust and network access models and can be adapted to various enterprise security frameworks.

The following data illustrates example improvement using CF vs. a convention approach, “before,” on three different data sets:

Data Set 1

| Metric | Before | CF | % Improved |
|---|---|---|---|
| Num Violations | 384 | 365 | 4.9% |
| Attack Surface Reduction | 0.86 | 0.88 | 2.27% |

Data Set 2

| Metric | Before | CF | % Improved |
|---|---|---|---|
| Num Violations | 693 | 398 | 42.5% |
| Attack Surface Reduction | 0.786 | 0.789 | 0.3% |

Data Set 3

| Metric | Before | CF | % Improved |
|---|---|---|---|
| Num Violations | 815 | 785 | 3.68% |
| Attack Surface Reduction | 0.649 | 0.651 | 0.3% |

### CONCLUSION

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A system comprising:
a processing device; and
a memory device configured to store a user-app prediction program having instructions that, when executed, enable the processing device to
obtain transaction logs that include a) user features related to a plurality of users of an organization, b) app features related to a plurality of apps used within the organization, and c) user-app interaction information related to requests by users to access apps in addition to responses to the requests to either permit or deny user access, and
apply a collaborative filtering technique on the transaction logs to train an Artificial Intelligence (AI) model for predicting whether a new user is legitimately permitted access to one or more of the plurality of apps.

2. The system of claim 1, wherein the user features include one or more of a) skills and/or expertise of a user, b) experience and/or background of the user, c) department and/or team to which the user is assigned, d) job title of the user, e) city, office, and/or location where the user works, f) projects on which the user contributes, g) a number of days, within a predetermined time period, that a user attempts to access any of the apps, and h) number of transactions that the user performs within the predetermined time period.

3. The system of claim 1, wherein the app features include one or more of a) a name of an app, b) an app type of the app, c) a domain name associated with the organization within which the app is used, d) IP address of network equipment associated with the app, and e) one or more ports to which the app is assigned.

4. The system of claim 1, wherein the instructions further enable the processing device to:
convert the user features for each user into a multi-dimensional user vector,
convert the app features for each app into a multi-dimensional app vector, and
utilize a connectivity graph to analyze similarities among user vectors, similarities among app vectors, and the user-app interaction information regarding access requests and responses to the requests to either permit or deny user access.

5. The system of claim 4, wherein analyzing similarities among user vectors and analyzing similarities among app vectors includes:
assigning weights to different user features and app features, and
calculating a prediction score based on the similarities in the connectivity graph.

6. The system of claim 4, wherein the instructions further enable the processing device to:
utilize a Strongest Connected Components (SCC) detection algorithm to determine similarities, and
apply results of the SCC detection algorithm to perform an app segmentation procedure to create an access policy for the organization.

7. The system of claim 1, wherein the transaction logs are historical transaction logs, and wherein the instructions further enable the processing device to retrain the AI model based on newly obtained user access information.

8. The system of claim 1, wherein the collaborative filtering technique is configured to enable the AI model to increase a number of true positives and true negatives and reduce a number of false positives and false negatives, whereby true positives are defined as correctly predicting user access permission to valid users, true negatives are defined as correcting predicting user access denial to invalid users, false positives are defined as incorrectly predicting user access permission to invalid users, and false negatives are defined as incorrectly predicting user access denial to valid users.

9. The system of claim 1, wherein the AI model is configured to automatically predict whether an access request would result in a user access permission or a user access denial without a need for a user to open a ticket.

10. The system of claim 1, wherein the system is arranged for implementation within a cloud-based zero trust platform and/or network access platform.

11. The system of claim 1, wherein the instructions further enable the processing device to periodically update an access policy defined by the AI model based on newly obtained transaction logs.

12. A method comprising the steps of:
obtaining transaction logs that include a) user features related to a plurality of users of an organization, b) app features related to a plurality of apps used within the organization, and c) user-app interaction information related to requests by users to access apps in addition to responses to the requests to either permit or deny user access; and
applying a collaborative filtering technique on the transaction logs to train an Artificial Intelligence (AI) model for predicting whether a new user is legitimately permitted access to one or more of the plurality of apps.

13. The method of claim 12, wherein the user features include one or more of a) skills and/or expertise of a user, b) experience and/or background of the user, c) department and/or team to which the user is assigned, d) job title of the user, e) city, office, and/or location where the user works, f) projects on which the user contributes, g) a number of days, within a predetermined time period, that a user attempts to access any of the apps, and h) number of transactions that the user performs within the predetermined time period.

14. The method of claim 12, wherein the app features include one or more of a) a name of an app, b) an app type of the app, c) a domain name associated with the organization within which the app is used, d) IP address of network equipment associated with the app, and e) one or more ports to which the app is assigned.

15. The method of claim 12, further comprising steps of:
converting the user features for each user into a multi-dimensional user vector;
converting the app features for each app into a multi-dimensional app vector; and
utilizing a connectivity graph to analyze similarities among user vectors, similarities among app vectors, and the user-app interaction information regarding access requests and responses to the requests to either permit or deny user access.

16. The method of claim 15, wherein analyzing similarities among user vectors and analyzing similarities among app vectors includes:
assigning weights to different user features and app features, and
calculating a prediction score based on the similarities in the connectivity graph.

17. The method of claim 15, further comprising steps of:
utilizing a Strongest Connected Components (SCC) detection algorithm to determine similarities; and
applying results of the SCC detection algorithm to perform an app segmentation procedure to create an access policy for the organization.

18. A non-transitory computer-readable medium configured to store computer logic having instructions that, when executed, cause one or more processing devices to:
obtain transaction logs that include a) user features related to a plurality of users of an organization, b) app features related to a plurality of apps used within the organization, and c) user-app interaction information related to requests by users to access apps in addition to responses to the requests to either permit or deny user access, and
apply a collaborative filtering technique on the transaction logs to train an Artificial Intelligence (AI) model for predicting whether a new user is legitimately permitted access to one or more of the plurality of apps.

19. The non-transitory computer-readable medium of claim 18, wherein the transaction logs are historical transaction logs, and wherein the instructions further enable the one or more processing devices to retrain the AI model based on newly obtained user access information.

20. The non-transitory computer-readable medium of claim 18, wherein the collaborative filtering technique is configured to enable the AI model to increase a number of true positives and true negatives and reduce a number of false positives and false negatives, whereby true positives are defined as correctly predicting user access permission to valid users, true negatives are defined as correcting predicting user access denial to invalid users, false positives are defined as incorrectly predicting user access permission to invalid users, and false negatives are defined as incorrectly predicting user access denial to valid users.
